(19) United States
(12) Patent Application Publication
(10) Pub. No.: US 2026/0112658 A1
(43) Pub. Date: Apr. 23, 2026

(54) SEPARATOR FOR FUEL CELL AND SINGLE CELL FOR FUEL CELL

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP); Akihiro INUKAI, Okazaki-shi (JP); Kensuke DOI, Obu-shi (JP)

(73) Assignee: TOYOTA BOSHOKU KABUSHIKI KAISHA, Aichi-ken (JP)

(21) Appl. No.: 19/362,961

(22) Filed: Oct. 20, 2025

(30) Foreign Application Priority Data
Oct. 22, 2024 (JP) 2024-185954

(51) Int. Cl. H01M 8/0258; H01M 8/0247

(52) U.S. Cl. CPC H01M 8/0258; H01M 8/0247

(57) ABSTRACT

A separator for a fuel cell includes a rectangular plate-shaped body. The body forms passages through which gas flows. The body includes central regions and a reversing region. The central regions extend along one side of the body, and are arranged in a direction in which another side of the body that intersects the one side extends. The passages include multiple central passage sections that extend in the longitudinal direction through each central region, and a reversing passage section that extends through the reversing region and connects the central passage sections of adjacent ones of the central regions. The ribs are formed such that two or more of the central passage sections are formed in each of the central regions, and the reversing passage section in the reversing region is connected to two or more of the central passage sections in the corresponding central region.

### CROSS-REFERENCE TO RELATED APPLICATIONS

This application is based upon and claims the benefit of priority from Japanese Patent Application No. 2024-185954, filed on Oct. 22, 2024, the entire contents of which are incorporated herein by reference.

### BACKGROUND

### 1. Field

The present disclosure relates to a separator for a fuel cell and a single cell for a fuel cell.

### 2. Description of Related Art

As disclosed in JP2005-190795A, a cell stack of a fuel cell is formed by stacking single cells for a fuel cell in the thickness direction. A single cell is formed by sandwiching a membrane electrode gas diffusion layer assembly with rectangular plate-shaped separators from the opposite sides in the thickness direction. The separator for a fuel cell includes a body having ribs that extend in parallel. The ribs protrude from the body to be in contact with the membrane electrode gas diffusion layer assembly. Passages through which gas flows are formed between the body and the membrane electrode gas diffusion layer assembly and between the ribs.

One of the opposite sides of the membrane electrode gas diffusion layer assembly in the thickness direction is an anode side, and the other side is a cathode side. Fuel gas (e.g., hydrogen) flows through the passage between the anode side of the membrane electrode gas diffusion layer assembly and the separator located on the anode side. Oxidation gas (e.g., air) flows through the passage between the cathode side of the membrane electrode gas diffusion layer assembly and the separator located on the cathode side. Power is generated in each single cell based on the reaction between the fuel gas and the oxidation gas at the membrane electrode gas diffusion layer assembly.

The body of each separator includes central regions and reversing regions. The central regions extend along one side of the body and are arranged in parallel in a direction intersecting the one side. The reversing regions extend along another side of the body and are positioned to correspond to the ends in the longitudinal direction of adjacent central regions. The passages are formed by multiple central passage sections, which extend through the central regions in the longitudinal direction, and reversing passage sections, which extend through the reversing regions and connect the central passage sections of adjacent ones of the central regions to each other. The passages, which include the central passage sections and the reversing passage sections, are formed in parallel. In other words, the ribs are formed on the body so as to define the multiple passages.

In each single cell, the separator on the anode side and the separator on the cathode side are identical components that are inverted front-to-back relative to one another. In the membrane electrode gas diffusion layer assembly of the above configuration, the direction of the flow of fuel gas in the central passage sections of the passages on the anode side is opposite to the direction of the flow of oxidation gas in the central passage sections of the passages on the cathode side.

In the membrane electrode gas diffusion layer assembly of a single cell, power generation efficiency is maximized when the flow direction of fuel gas flowing through the passages on the anode side is opposite to the flow direction of oxidation gas flowing through the passages on the cathode side. Accordingly, it is preferable to make the central passage sections of the passages as long as possible in order to increase the power generation efficiency of the single cell.

The body of the separator in the above publication includes multiple reversing passage sections connected to multiple central passage sections of the passages. Accordingly, in order to lengthen the central passage sections of the passages, one approach is to reduce the collective width of the reversing passage sections in the direction in which the central passage sections extend

However, since the number of the reversing passage sections is the same as the number of the central passage sections in each central region, there is a limit to the extent to which the collective width of the reversing passage sections can be reduced in the extending direction of the central passage sections. Accordingly, since the length of the central passage sections of the passages cannot readily be increased, significantly improving the power generation efficiency of the single cell has been difficult.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a separator for a fuel cell includes a rectangular plate-shaped body that can be disposed on either side in a thickness direction of a membrane electrode gas diffusion layer assembly. The body forms passages through which gas flows between the body and the membrane electrode gas diffusion layer assembly. The body includes central regions and a reversing region. The central regions extend along one side of the body, and are arranged in a direction in which an other side of the body that intersects the one side extends. The reversing region extends along the other side of the body and is located at a position corresponding to ends of adjacent ones of the central regions in a longitudinal direction. The passages include multiple central passage sections that extend in the longitudinal direction through each central region, and a reversing passage section that extends through the reversing region and connects the central passage sections of adjacent ones of the central regions. The body includes multiple ribs that protrude toward the membrane electrode gas diffusion layer assembly to be in contact with the membrane electrode gas diffusion layer assembly. The passages are formed between the ribs. The ribs are formed such that two or more of the central passage sections are formed in each of the central regions, and the reversing passage section in the reversing region is connected to two or more of the central passage sections in the corresponding central region.

In another general aspect, a single cell for a fuel cell includes a membrane electrode gas diffusion layer assembly, and two separators that sandwich the membrane electrode gas diffusion layer assembly from opposite sides in a thickness direction. The separators are inverted front-to-back relative to one another. Passages through which gas flows are formed between the separator and the membrane electrode gas diffusion layer assembly. The separator includes central regions and a reversing region. The central regions extend along one side of the separator, and are arranged in a direction in which an other side of the separator that intersects the one side extends. The reversing region extends along the other side of the separator and is located at a position corresponding to ends of adjacent ones of the central regions in a longitudinal direction. The passages include multiple central passage sections that extend in the longitudinal direction through each central region, and a reversing passage section that extends through the reversing region and connects the central passage sections of adjacent ones of the central regions. The separator includes multiple ribs that protrude toward the membrane electrode gas diffusion layer assembly to be in contact with the membrane electrode gas diffusion layer assembly. The passages are formed between the ribs. The ribs are formed such that two or more of the central passage sections are formed in each of the central regions, and the reversing passage section in the reversing region is connected to two or more of the central passage sections in the corresponding central region.

Other features and aspects will be apparent from the following detailed description, the drawings, and the claims.

### BRIEF DESCRIPTION OF THE DRAWINGS

FIG. 1 is an exploded perspective view showing a single cell of a fuel cell.

FIG. 2 is a cross-sectional view of a cell stack in which single cells having the structure shown in FIG. 1 are stacked.

FIG. 3 is a plan view showing a front of the body of one of the separators shown in FIG. 1.

FIG. 4 is a plan view showing a back of the body of one of the separators shown in FIG. 1.

FIG. 5 is a plan view showing a state in which the separator on the anode side and the separator on the cathode side in the single cell shown in FIG. 1 are stacked.

FIG. 6 is a schematic cross-sectional view of a reversing passage section in a reversing region in the separator shown FIGS. 3 and 4, and its surroundings.

FIG. 7 is a plan view showing a comparative example of a separator.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

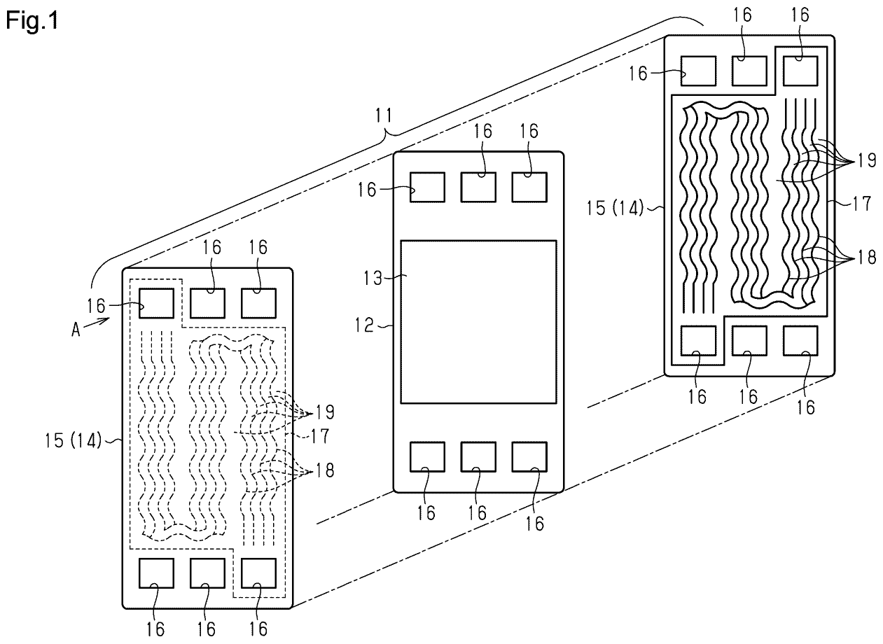

A separator 14 for a fuel cell and a single cell 11 for a fuel cell according to an embodiment will now be described with reference to FIGS. 1 to 7.

FIG. 1 shows a single cell 11 used to form a cell stack of a fuel cell. The single cell 11 includes a plastic plate 12, a membrane electrode gas diffusion layer assembly 13, and separators 14. The plastic plate 12 is formed to have the shape of a rectangular frame. The outer edge of the membrane electrode gas diffusion layer assembly 13 is joined to the plastic plate 12. The plastic plate 12 and the membrane electrode gas diffusion layer assembly 13 are sandwiched by the separators 14, which are respectively arranged on the opposite sides in the thickness direction. Each separator 14 is formed into the shape of a rectangular plate corresponding to the outer shape of the plastic plate 12.

The cell stack of the fuel cell is formed by stacking multiple single cells 11 in the thickness direction. The plastic plates 12 and the separators 14 of the cells 11 each have holes 16. Three of the holes 16 are located at one end of the single cell 11 in the long-side direction, and the other three are located at the other end of the single cell 11 in the long-side direction. One of the holes 16 at one end in the long-side direction of the single cell 11 is paired with one of the holes 16 at the other end. Each pair of the holes 16 is used to allow a fluid (e.g. fuel gas such as hydrogen, oxidation gas such as air, or coolant) to flow therethrough.

The separators 14 each include a body 15 that is made of metal (e.g., stainless steel, titanium, or aluminum) and formed to have the shape of a rectangular plate. The body 15 includes multiple ribs 19 that are parallel to each other. A seal member 17 is arranged between the body 15 of each separator 14 and the plastic plate 12. The seal member 17 can be provided on both the front and back surfaces of the plastic plate 12 in the thickness direction.

The seal member 17, arranged on the front surface of the plastic plate 12, surrounds a pair of the holes 16, the pair being positioned on one of the two diagonal lines of the plastic plate 12 and the corresponding separator 14. The seal member 17 also surrounds the anode side of the membrane electrode gas diffusion layer assembly 13. The seal member 17 also surrounds the ribs 19 in the separator 14 on the anode side. Further, a passage 18 through which fuel gas flows is defined between adjacent ones of the ribs 19 in the separator 14. Fuel gas can be supplied to the passages 18 through the pair of holes 16.

Also, the seal member 17 arranged on the back side of the plastic plate 12 surrounds a pair of the holes 16 positioned on the other one of the two diagonal lines of the plastic plate 12 and the corresponding separator 14. The seal member 17 also surrounds the cathode side of the membrane electrode gas diffusion layer assembly 13. The seal member 17 also surrounds the ribs 19 in the separator 14 on the cathode side. Further, a passage 18 through which oxidation gas flows is defined between adjacent ones of the ribs 19 in the separator 14. Oxidation gas can be supplied to the passages 18 through the pair of holes 16.

In the cell stack of the single cells 11, the separator 14 on the anode side of any one of the single cells 11 and the separator 14 on the cathode side of another single cell 11 are adjacent to each other. The adjacent separators 14 are welded together around two pairs of holes 16 disposed on the diagonals of the separators 14, but are not welded together around the holes 16 located at the center of each short side of the separators 14. Also, the outer edges of the adjacent separators 14 are welded to each other. This allows coolant to flow through the space between the adjacent separators 14 via the holes 16 located at the center of the separators 14 in the short-side direction.

In the fuel cell stack of the single cells 11, the fuel gas flows along the anode side of the membrane electrode gas diffusion layer assembly 13, and the oxidation gas flows along the cathode side of the membrane electrode gas diffusion layer assembly 13. When the fuel gas and the oxidation gas respectively flow along the anode side and the cathode side of the membrane electrode gas diffusion layer assembly 13, power is generated based on the reaction between the fuel gas and the oxidation gas in the membrane electrode gas diffusion layer assembly 13. In order to limit an increase in the temperature of the cell stack caused by such power generation, the coolant flows through the space between the separators 14 of adjacent single cells 11 as described above. The coolant cools the cell stack.

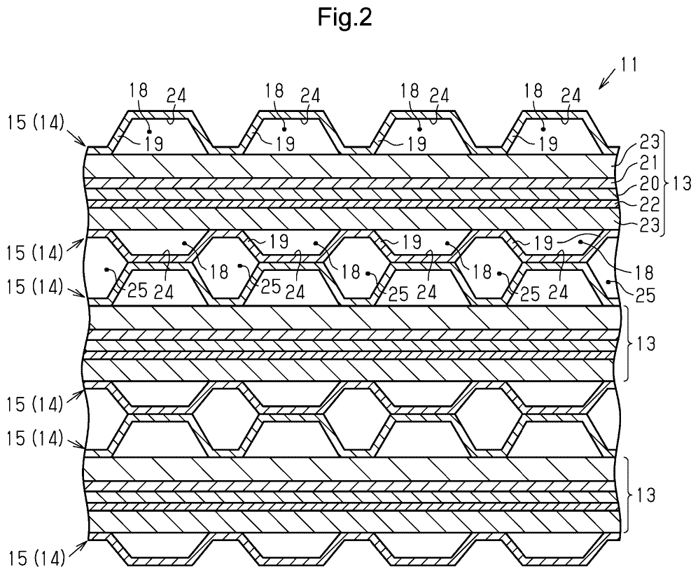

As shown in FIG. 2, the membrane electrode gas diffusion layer assembly 13 of each single cell 11 includes an electrolyte layer 20, a cathode electrode layer 21, an anode electrode layer 22, and a gas diffusion layer 23. The electrolyte layer 20 is formed by, for example, a solid polymer membrane. The cathode electrode layer 21 is joined to one side of the electrolyte layer 20 in the thickness direction (the upper side in FIG. 1). The anode electrode layer 22 is joined to the other side in the thickness direction of the electrolyte layer 20 (the lower side in FIG. 1). The surface of the cathode electrode layer 21 opposite to the electrolyte layer 20 is covered by the gas diffusion layer 23. The surface of the anode electrode layer 22 opposite to the electrolyte layer 20 is covered by another gas diffusion layer 23, which is different from the aforementioned gas diffusion layer 23.

Two separators 14 are respectively located on the cathode side and the anode side of the membrane electrode gas diffusion layer assembly 13. The ribs 19 in each separator 14 are formed by bending the body 15 of the separator 14 so as to protrude in the thickness direction of the separator 14. The separator 14 on the cathode side of the membrane electrode gas diffusion layer assembly 13 and the separator 14 on the anode side of the membrane electrode gas diffusion layer assembly 13 have the same shape. However, the cathode-side separator 14 is inverted front-to-back relative to the anode-side separator 14 in the thickness direction.

The multiple ribs 19 of the cathode-side separator 14 protrude toward the gas diffusion layer 23 on the cathode side. These ribs 19 are in contact with the gas diffusion layer 23 on the cathode side. The spaces between the ribs 19 of the separator 14 and between the body 15 of the separator 14 and the gas diffusion layer 23 form passages 18 through which oxidation gas flows. The multiple ribs 19 of the anode-side separator 14 protrude toward the gas diffusion layer 23 on the anode side. These ribs 19 are in contact with the gas diffusion layer 23 on the anode side. The spaces between the ribs 19 of the separator 14 and between the body 15 of the separator 14 and the gas diffusion layer 23 form passages 18 through which fuel gas flows.

A space between the adjacent separators 14 serves as a passage 25 through which the coolant flows. Specifically, the adjacent separators 14 are in contact with each other at portions corresponding to bottoms 24 of the passages 18 in the bodies 15. The passage 25 is formed between the bodies 15 of the adjacent separators 14 at positions other than the portions that are in contact with each other.

### Details of the Ribs 19 and the Passages 18

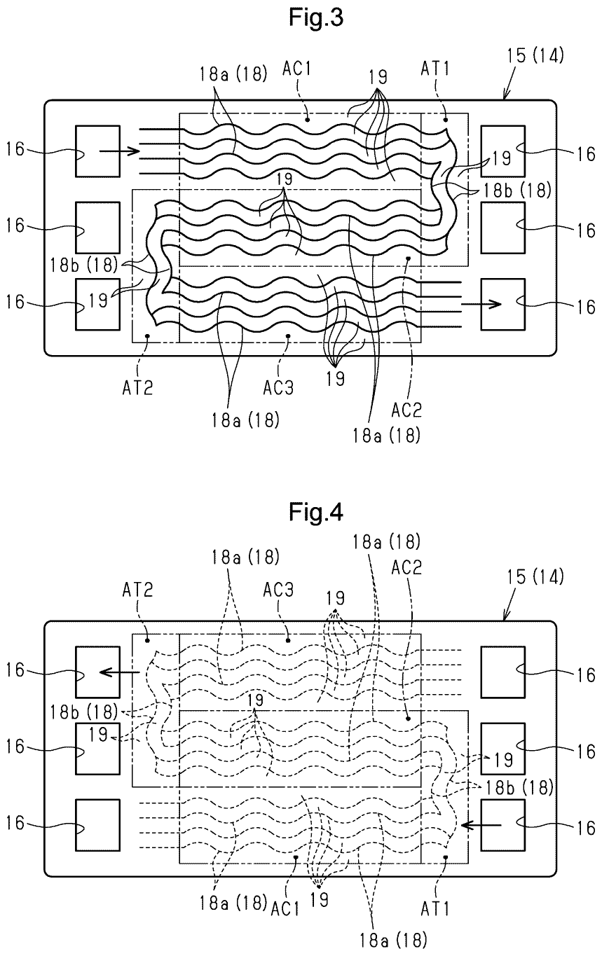

FIG. 3 shows the front side of the separator 14 that is in contact with the anode side of the membrane electrode gas diffusion layer assembly 13. FIG. 4 shows the back side of the separator 14 that is in contact with the cathode side of the membrane electrode gas diffusion layer assembly 13.

As shown in FIGS. 3 and 4, each body 15 includes central regions AC1, AC2, AC3 and a reversing regions AT1, AT2. The central regions AC1, AC2, AC3 extend along a long side, which is one side of the body 15, and are arranged along a short side, which is another side intersecting the long side. The reversing regions AT1, AT2 extend along the short side of the body 15 and are each located at a position corresponding to the ends in the longitudinal direction of adjacent ones of the central regions AC1, AC2, AC3.

The ribs 19, which form the passages 18, are formed on the body 15 so as to extend in a wavelike manner. Accordingly, the passages 18 formed between the ribs 19 extend in a wavelike manner in correspondence with the ribs 19. The passages 18 include central passage sections 18a and reversing passage sections 18b. The central passage sections 18a extend through each of the central regions AC1, AC2, AC3 in the longitudinal direction. Each of the central regions AC1, AC2, AC3 include multiple central passage sections 18a. The reversing passage sections 18b extend through the reversing regions AT1, AT2 in the longitudinal direction, and connect the central passage sections 18a of adjacent ones of the central regions AC1, AC2, AC3.

The ribs 19 in the body 15 are formed as follows. The ribs 19 are formed such that multiple central passage sections 18a are formed in each of the central regions AC1, AC2, AC3, and the reversing passage sections 18b in each of the reversing regions AT1, AT2 are connected to the central passage sections 18a in the corresponding one of the central regions AC1, AC2, AC3. The ribs 19 are formed such that the reversing regions AT1, AT2 each include multiple reversing passage sections 18b. Further, the ribs 19 are formed such that the width of each central passage section 18a and the width of each reversing passage section 18b in the passages 18 are constant.

### Details of the Central Passage Sections 18a and the Reversing Passage Sections 18b

The central regions AC1, AC2, AC3 include three regions: a first central region AC1, a second central region AC2, and a third central region AC3. Further, the reversing regions AT1, AT2 include two regions: a first reversing region AT1 and a second reversing region AT2.

The first central region AC1 and the second central region AC2 are adjacent to each other, and the reversing passage sections 18b in the first reversing region AT1 connect the central passage sections 18a of the first central region AC1 and the central passage sections 18a of the second central region AC2 to each other at one end in the longitudinal direction. The second central region AC2 and the third central region AC3 are adjacent to each other, and the reversing passage sections 18b in the second reversing region AT2 connect the central passage sections 18a of the second central region AC2 and the central passage sections 18a of the third central region AC3 to each other at the other end in the longitudinal direction.

The number of the central passage sections 18a in the first central region AC1, the number of the central passage sections 18a in the second central region AC2, and the number of the central passage sections 18a in the third central region AC3 are equal. The number of the reversing passage sections 18b in the first reversing region AT1 and the number of the reversing passage sections 18b in the second reversing region AT2 are equal. In other words, the ribs 19 are formed in the body 15 so as to achieve this configuration.

The Passage 25 and the Bottoms 24 of the Passages 18 in the Body 15

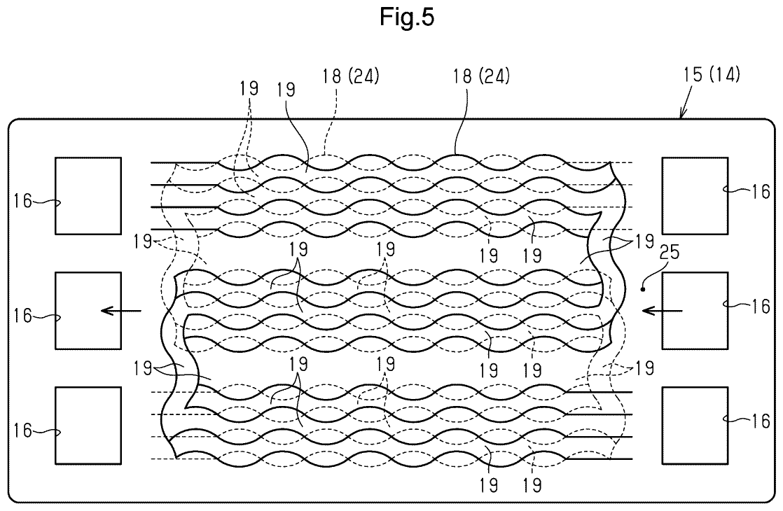

FIG. 5 shows a difference in the direction in which the passages 18 extend when the anode-side separator 14 and the cathode-side separator 14 in each single cell 11 are stacked. As shown in FIG. 5, the anode-side separator 14 and the cathode-side separator 14 are inverted front-to-back relative to one another in the thickness direction. In single cells 11 adjacent to each other in the cell stack of the fuel cell, the anode-side separator 14 and the cathode-side separator 14 are in contact with each other at portions corresponding to the bottoms 24 of the passages 18 in the bodies 15.

Since the ribs 19 of the bodies 15 are formed so as to extend in a wavelike manner, the portions of the bodies 15 corresponding to the bottoms 24 of the passages 18 extend in a wavelike manner along the ribs 19. However, as described above, the anode-side separator 14 and the cathode-side separator 14 are inverted front-to-back relative to each other. Accordingly, the extending direction of the portions in the anode-side separator 14 that correspond to the bottoms 24 of the passages 18 differs from the extending direction of the portions in the cathode-side separator 14 that correspond to the bottoms 24 of the passages 18.

As a result, the portions in the anode-side separator 14 that correspond to the bottoms 24 of the passages 18 and the portions in the cathode-side separator 14 that correspond to the bottoms 24 of the passages 18 contact each other at intersecting positions. Further, between the anode-side separator 14 and the cathode-side separator 14, the passage 25, through which coolant flows, is formed at positions other than the above-described positions where the separators 14 contact each other. The coolant flows through the passage 25 from one of the two holes 16 located at the center in the short-side direction of the bodies 15 of the separators 14 to the other hole 16 as indicated by arrows.

The present embodiment, as described above, has the following operational advantages.

(1) In the passages 18 formed in the bodies 15 of the separators 14 in each single cell 11 of the fuel cell, each of the reversing passage sections 18b in the reversing regions AT1, AT2 is connected to two or more of the central passage sections 18a in the corresponding one of the central regions AC1, AC2, AC3. Accordingly, the number of the reversing passage sections 18b in each of the regions AT1, AT2 can be made smaller than the number of the central passage sections 18a in each of the central regions AC1, AC2, AC3. This reduces the collective width of the reversing passage sections 18b in the direction in which the central regions AC1, AC2, AC3 extend. In other words, the width of each of the reversing regions AT1, AT2 is reduced. As the width of each of the reversing regions AT1, AT2 is thus reduced, the central regions AC1, AC2, AC3 and the central passage sections 18a can be lengthened.

Since the membrane electrode gas diffusion layer assembly 13 is sandwiched from the anode side and the cathode side by the two separators 14, which are inverted front-to-back relative to one another, the flow of gas in the passages 18 on the anode side and the flow of gas in the passages 18 on the cathode side are as follows. The flow direction of gas flowing through the central passage sections 18a of the passages 18 on the anode side is opposite to the flow direction of gas flowing through the central passage sections 18a of the passages 18 on the cathode side. Causing the gas to flow in opposite directions between the central passage sections 18a on the anode side and the central passage sections 18a on the cathode side improves the power generation efficiency of the membrane electrode gas diffusion layer assembly 13. Since the central passage sections 18a are lengthened as described above, the power generation efficiency is improved effectively.

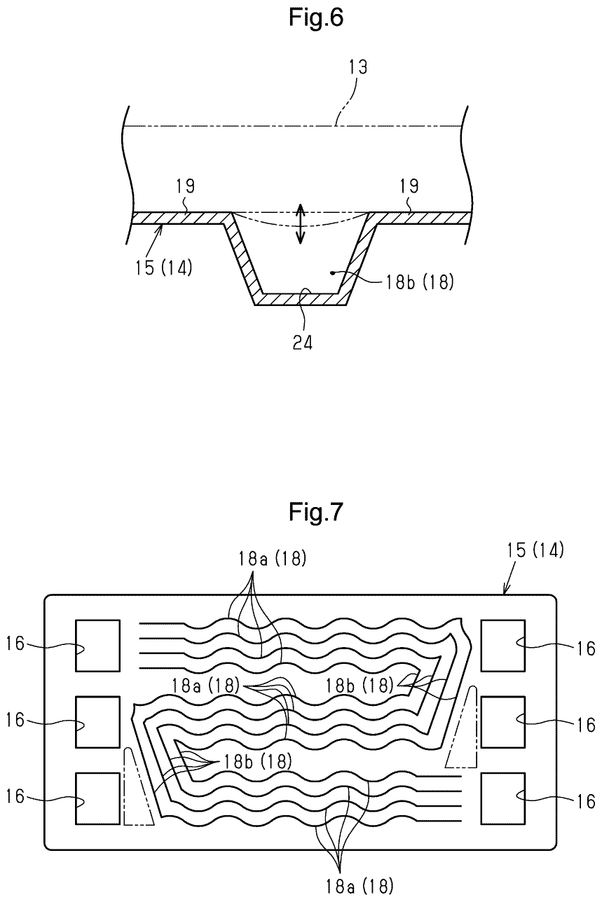

(2) In the reversing regions AT1, AT2 of the body 15, the ribs 19 for forming the reversing passage sections 18b are in contact with the membrane electrode gas diffusion layer assembly 13. Accordingly, the ribs 19 suppress pressure fluctuations within the passages 18, which would otherwise cause the membrane electrode gas diffusion layer assembly 13 to bulge into and retract from the reversing passage sections 18b as indicated by the arrows in FIG. 6. This suppresses degradation of the membrane electrode gas diffusion layer assembly 13 due to such fluctuations of the membrane electrode gas diffusion layer assembly 13.

(3) Since the widths of the central passage sections 18a and the reversing passage sections 18b in the passages 18 are constant, the area of the membrane electrode gas diffusion layer assembly 13 exposed to the reversing passage sections 18b is not excessively large. Consequently, the membrane electrode gas diffusion layer assembly 13 is unlikely to bulge into and retract from the reversing passage sections 18b in response to pressure variations within the passages 18, as indicated by the arrows in FIG. 6. This suppresses degradation of the membrane electrode gas diffusion layer assembly 13 due to such fluctuations of the membrane electrode gas diffusion layer assembly 13.

(4) The number of the central passage sections 18a in the first central region AC1, the number of the central passage sections 18a in the second central region AC2, and the number of the central passage sections 18a in the third central region AC3 are equal. The number of the reversing passage sections 18b in the first reversing region AT1 and the number of the reversing passage sections 18b in the second reversing region AT2 are equal. This suppresses uneven distribution of the gas supplied to the membrane electrode gas diffusion layer assembly 13 through the passages 18. The configuration thus prevents premature shortening of the service life of the membrane electrode gas diffusion layer assembly 13 due to uneven gas distribution of the gas flowing through the passage 18 to the membrane electrode gas diffusion layer assembly 13.

(5) Each single cell 11 of the fuel cell includes the membrane electrode gas diffusion layer assembly 13, and the two separators 14 that sandwich the membrane electrode gas diffusion layer assembly 13 from the anode side and the cathode side, and are inverted front-to-back relative to one another. Further, a cell stack is formed using the single cells 11 as follows. Specifically, a cell stack is formed by stacking the single cells 11 in the thickness direction. In each adjacent pair of the single cells 11 in such a cell stack, the separators 14 are adjacent to each other, and portions corresponding to the bottoms 24 of the passages 18 between the ribs 19 are in contact with each other. In such a configuration, since the ribs 19 in the body 15 of the separator 14 extend in a wavelike manner, portions corresponding to the bottoms 24 of the passages 18 between the ribs 19 also extend in a wavelike manner. When such portions are in contact with each other, they extend in different directions. As a result, the portions do not interlock with one another. Accordingly, when the cell stack is compressed in the stacking direction of the single cells 11, a reduction in the surface pressure transmitted from the body 15 of the separator 14 to the membrane electrode gas diffusion layer assembly 13, which would otherwise degrade power generation efficiency, is prevented.

(6) As shown in FIG. 7, even when the reversing passage sections 18b are formed as straight lines inclined with respect to the short sides of the body 15 of each separator 14, the portions corresponding to the bottoms 24 of the passages 18 between the ribs 19 extend in different directions when the adjacent ones of separators 14 are brought into contact with each other. Thus, interlocking of such portions is avoided, and a reduction in the surface pressure transmitted from the body 15 to the membrane electrode gas diffusion layer assembly 13 when the cell stack is compressed in the stacking direction of the single cells 11 is suppressed, thereby preventing deterioration of power generation efficiency. However, if the reversing passage sections 18b are formed as straight lines inclined with respect to the short sides of the body 15 of the separator 14, portions of the passages 18 lacking reversing passage sections 18b become larger, as shown by the long-dash double-short-dash lines in FIG. 7. This leads to a decrease in power generation efficiency.

In contrast, since the reversing passage sections 18b are formed to extend in a wavelike manner as shown in FIGS. 3 and 4, there is no significant increase in the portions that lack reversing passage sections 18b of the passages 18, unlike the case indicated by the long-dash double-short-dash lines in FIG. 7. Accordingly, a reduction in power generation efficiency due to enlargement of such portions is suppressed.

The above-described embodiment may be modified as follows. The above-described embodiment and the following modifications can be combined as long as the combined modifications remain technically consistent with each other.

Either or both of the central passage sections 18a and the reversing passage sections 18b in the passage 18 may be formed to extend in a straight line.

The number of the reversing passage sections 18b in the first reversing region AT1 may be different from the number of the reversing passage sections 18b in the second reversing region AT2. In this case, the number of the reversing passage sections 18b in one of the first reversing region AT1 and the second reversing region AT2 may agree with the number of the central passage sections 18a in the central regions AC1, AC2, AC3.

The number of the central passage sections 18a in the first central region AC1, the number of the central passage sections 18a in the second central region AC2, and the number of the central passage sections 18a in the third central region AC3 do not necessarily need to be equal.

The widths of the central passage sections 18a and the reversing passage sections 18b in the passages 18 do not necessarily need to be constant.

The number of the reversing passage sections 18B in the first reversing region AT1 may be only one, or the number of the reversing passage sections 18b in the second reversing region AT2 may be only one.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A separator for a fuel cell, comprising a rectangular plate-shaped body that can be disposed on either side in a thickness direction of a membrane electrode gas diffusion layer assembly, wherein
the body forms passages through which gas flows between the body and the membrane electrode gas diffusion layer assembly,
the body includes central regions and a reversing region,
the central regions extend along one side of the body, and are arranged in a direction in which an other side of the body that intersects the one side extends,
the reversing region extends along the other side of the body and is located at a position corresponding to ends of adjacent ones of the central regions in a longitudinal direction,
the passages include:
multiple central passage sections that extend in the longitudinal direction through each central region, and
a reversing passage section that extends through the reversing region and connects the central passage sections of adjacent ones of the central regions,
the body includes multiple ribs that protrude toward the membrane electrode gas diffusion layer assembly to be in contact with the membrane electrode gas diffusion layer assembly,
the passages are formed between the ribs, and
the ribs are formed such that two or more of the central passage sections are formed in each of the central regions, and the reversing passage section in the reversing region is connected to two or more of the central passage sections in the corresponding central region.

2. The separator for the fuel cell according to claim 1, wherein the ribs in the body are formed such that the reversing passage section is one of multiple reversing passage sections in the reversing region.

3. The separator for the fuel cell according to claim 1, wherein the ribs are formed such that a width of each central passage section and a width of the reversing passage section in the passages are constant.

4. The separator for the fuel cell according to claim 1, wherein
the central regions include a first central region, a second central region, and a third central region,
the reversing region is one of multiple reversing regions that include a first reversing region and a second reversing region,
the first central region and the second central region are adjacent to each other, and the reversing passage section in the first reversing region connects the central passage sections of the first central region and the central passage sections of the second central region to each other at one end in the longitudinal direction,
the second central region and the third central region are adjacent to each other, and the reversing passage section in the second reversing region connects the central passage sections of the second central region and the central passage sections of the third central region to each other at an other end in the longitudinal direction, and
the ribs are formed such that
a number of the central passage sections in the first central region, a number of the central passage sections in the second central region, and a number of the central passage sections in the third central region are equal, and
a number of the reversing passage section in the first reversing region and a number of the reversing passage section in the second reversing region are equal.

5. The separator for the fuel cell according to claim 1, wherein the ribs are formed on the body so as to extend in a wavelike manner.

6. A single cell for a fuel cell, comprising:
a membrane electrode gas diffusion layer assembly; and
two separators that sandwich the membrane electrode gas diffusion layer assembly from opposite sides in a thickness direction, the separators being inverted front-to-back relative to one another, wherein
passages through which gas flows are formed between the separator and the membrane electrode gas diffusion layer assembly,
the separator includes central regions and a reversing region,
the central regions extend along one side of the separator, and are arranged in a direction in which an other side of the separator that intersects the one side extends,
the reversing region extends along the other side of the separator and is located at a position corresponding to ends of adjacent ones of the central regions in a longitudinal direction,
the passages include:
multiple central passage sections that extend in the longitudinal direction through each central region, and
a reversing passage section that extends through the reversing region and connects the central passage sections of adjacent ones of the central regions,
the separator includes multiple ribs that protrude toward the membrane electrode gas diffusion layer assembly to be in contact with the membrane electrode gas diffusion layer assembly,
the passages are formed between the ribs, and
the ribs are formed such that two or more of the central passage sections are formed in each of the central regions, and the reversing passage section in the reversing region is connected to two or more of the central passage sections in the corresponding central region.
